(19) United States
(12) Patent Application Publication
(10) Pub. No.: US 2004/0095227 A1
(43) Pub. Date: May 20, 2004

(54) Wireless alarm system

(76) Inventor: Harry J. Lehman, Denver, PA (US)

Correspondence Address: Richard C. Litman, LITMAN LAW OFFICES, LTD, P.O. Box 15035, Arlington, VA, 22215, US

(21) Appl. No.: 10/677,799

(22) Filed: Oct. 3, 2003

Related U.S. Application Data
(60) Provisional application No. 60/427,253, filed on Nov. 19, 2002.

(51) Int. Cl. B60Q 1/00

(52) U.S. Cl. 340/425.5; 340/568.1; 340/539.1

(57) ABSTRACT

A wireless alarm system to protect the cargo area of a truck and containers therein includes a master control unit, a slave unit(s), and a remote unit(s). A truck driver may carry a remote unit so that the driver may be alerted when the door of the cargo area of the truck is opened by an unauthorized individual, or if separation between the cargo area of the truck and the cab of the truck exceeds a predetermined distance threshold.

### CROSS-REFERENCE TO RELATED APPLICATION

This application claims the benefit of U.S. Provisional Patent Application Serial No. 60/427,253, filed Nov. 19, 2002, which is incorporated herein by reference.

### BACKGROUND OF THE INVENTION

1. Field of the Invention

The present invention relates to an alarm system for a truck and, more particularly, to a wireless alarm system to protect the cargo area and containers of trucks during transit.

2. Description of Related Art

Trucks are widely used to carry goods along roadways. Without protection, the cargo area and containers of trucks are subject to theft by unauthorized individuals. A number of systems are currently available to provide surveillance of cargo areas and containers of trucks. However, these systems are generally very complicated, difficult to install, expensive, and are usually incorporated into trucking fleets. There is a need to provide independent truck drivers with an inexpensive and easily installable alarm system to alert a truck driver who may have fallen asleep and/or be away from his vehicle when he is sleeping, eating, etc.

The related art is represented by the following references of interest.

U.S. Patent Application Publication No. 2001/0013833 A1, published on Aug. 16, 2001 for Chau-Ho Chen et al., describes a vehicle security system for performing selectable vehicle security functions that are programmable in a wireless fashion. The Chen et al. application does not suggest a wireless alarm system according to the claimed invention.

U.S. Patent Application Publication No. 2002/0021242 A1, published on Feb. 21, 2002 for Kenneth E. Flick, describes a tracking system which includes a vehicle tracking unit that communicates with a monitoring station. The Flick application does not suggest a wireless alarm system according to the claimed invention.

U.S. Patent Application Publication No. 2002/0027502 A1, published on Mar. 7, 2002 for Dwight Mayor, describes a stand alone alarm system and a kit for vehicles. The Mayor application does not suggest a wireless alarm system according to the claimed invention.

U.S. Patent Application Publication No. 2002/0041238 A1, published on Apr. 11, 2002 for Roderick M. Johnson et al., describes a remote monitoring system which uses a bi-directional pager communications system for monitoring remote monitoring stations. The Johnson et al. application does not suggest a wireless alarm system according to the claimed invention.

U.S. Patent Application Publication No. 2002/0049523 A1, published on Apr. 25, 2002, and U.S. Pat. No. 6,356,822 B1, issued on Mar. 12, 2002, for R. Gary Diaz et al., describe a communication system architecture for a vehicle which may be integrated into the vehicle's multiplexed electronic component communication system, and a process for communicating with the vehicle to provide information for and about the vehicle's operational status and coordinating the vehicle's activities. The Diaz et al. application and patent do not suggest a wireless alarm system according to the claimed invention.

U.S. Patent Application Publication No. 2002/0057764 A1, published on May 16, 2002 for Angelo Salvucci et al., describes a telephone service method within a telephone system that provides third-party notification whenever a call to an emergency service has occurred by placing real-time incident and response information content into an outbound notification call to a list of predetermined telephone numbers. The Salvucci et al. application does not suggest a wireless alarm system according to the claimed invention.

U.S. Patent Application Publication No. 2002/0060625 A1, published on May 23, 2002 for Alan Lesesky et al., describes an apparatus and methods of data communication between a heavy duty vehicle and a remote data communication terminal so that various operating characteristics of the vehicle can be monitored or observed. The Lesesky et al. application does not suggest a wireless alarm system according to the claimed invention.

U.S. Patent Application Publication No. 2002/0061758 A1, published on May 23, 2002 for Gary A. Zarlengo et al., describes a system for automating the operations of a fleet of commercial vehicles so that a party in interest can review current data concerning any particular vehicle and its cargo. The Zarlengo application does not suggest a wireless alarm system according to the claimed invention.

U.S. Patent Application Publication No. 2002/0067253 A1, published on Jun. 6, 2002 for Miroslav Trajkovic et al., describes a method and apparatus for the display of alarm information on a portable device. The Trajkovic et la. application does not suggest a wireless alarm system according to the claimed invention.

U.S. Pat. No. 3,961,323, issued on Jun. 1, 1976 to Albert W. Hartkorn, describes a method and apparatus for maintaining mobile cargo containers under surveillance when stored in a transportation terminal by use of a wireless radio system. The Hartkorn patent does not suggest a wireless alarm system according to the claimed invention.

U.S. Pat. No. 4,577,182, issued on Mar. 18, 1976 to James W. Millsap et al., describes an alarm system where an alarm condition automatically causes a cellular transceiver to transmit a telephone call to an alarm monitoring station by over-the-air transmission of a signal to a cellular site. The Millsap et al. patent does not suggest a wireless alarm system according to the claimed invention.

U.S. Pat. No. 5,223,844 and U.S. Reexamination Certificate B1 5,223,844, issued on Jun. 29, 1993 and Jan. 25, 2000, respectively, to John P. Mansell et al., describes a vehicle tracking and security system which allows immediate response in case of vehicle theft, an accident, vehicle breakdown, or other emergency. The Mansell et al. patent and reexamination certificate do not suggest a wireless alarm system according to the claimed invention.

U.S. Pat. No. 5,557,254, issued on Sep. 17, 1996 to Sam Johnson et al., describes a security system having two-way communication with a central monitoring station. The Johnson et al. patent does not suggest a wireless alarm system according to the claimed invention.

U.S. Pat. No. 5,640,139, issued on Jun. 17, 1997 to Gerald W. Egeberg, describes a system for preventing theft of cargo from a cargo area of a truck. The Egeberg patent does not suggest a wireless alarm system according to the claimed invention.

U.S. Pat. No. 5,892,442, issued on Apr. 6, 1999 to Nissim Ozery, describes a two-way pager alarm system for a home or business that reports to a security monitoring center in a wireless fashion. The Ozery patent does not suggest a wireless alarm system according to the claimed invention.

U.S. Pat. No. 6,011,321, issued on Jan. 4, 2000 to Dumitru V. Stancu et al., describes a page receiver system for disconnecting an electrical system from a power source and preventing manual reconnection of the electrical system to the power source. The Stancu et al. patent does not suggest a wireless alarm system according to the claimed invention.

U.S. Pat. No. 6,057,779, issued on May 2, 2000 to Benjamin G. Bates, describes a method of controlling access to a movable container and to a compartment of a vehicle, and a secure cargo transportation system. The Bates patent does not suggest a wireless alarm system according to the claimed invention.

U.S. Pat. No. 6,166,627, issued on Dec. 26, 2000 to Ronald B. Reeley, describes a mobile detection and alert vehicle tracking and security system for an individual as well as a plurality of individual vehicles in a given security area. The Reeley patent does not suggest a wireless alarm system according to the claimed invention.

U.S. Pat. No. 6,311,060 B1, issued on Oct. 30, 2001 to Thomas F. Evans et al., describes a method and system for registering the location of a mobile cellular communication device. The Evans et al. patent does not suggest a wireless alarm system according to the claimed invention.

None of the above inventions and patents, taken either singly or in combination, is seen to describe the instant invention as claimed.

### SUMMARY OF THE INVENTION

The present invention provides a wireless alarm system to protect the cargo area of a truck and containers therein. The wireless alarm system includes a master control unit, a slave unit(s), and a remote unit(s). A truck driver may carry a remote unit so that the driver may be alerted when the door of the cargo area of the truck is opened by an unauthorized individual, or if separation between the cargo area of the truck and the cab of the truck exceeds a predetermined distance threshold.

Accordingly, it is a principal aspect of the invention to provide a wireless alarm system wireless alarm system including a master control unit, a slave unit(s), and a remote unit(s), wherein the wireless alarm system protects a cargo area of a truck and any containers contained therein.

It is another aspect of the invention to provide a wireless alarm system including a master control unit, a slave unit(s), and a remote unit(s), wherein the master control unit includes a control button(s), a visual indicator(s), an audible indicator(s), an input/output connector(s), a transceiver, a processor, a memory, an antenna, and a communication bus to communicatively interconnect the control button(s), the visual indicator(s), the audible indicator(s), the input/output connector(s), the transceiver, the processor, the memory, and the antenna of the master control unit.

It is a further aspect of the invention to provide a wireless alarm system including a master control unit, a slave unit(s), and a remote unit(s), wherein the slave unit includes a visual indicator(s), a lock, an input/output connector(s), a power source, a transceiver, a processor, a memory, an antenna, and a communication bus to communicatively interconnect the at least one visual indicator, the lock, the input/output connector(s), the power source, the transceiver, the processor, the memory, and the antenna of the slave unit(s).

Yet another aspect of the invention to provide a wireless alarm system including a master control unit, a slave unit(s), and a remote unit(s), wherein the remote unit(s) include a visual indicator(s), an audible indicator(s), a transceiver, a power source, a processor, a memory device(s), an antenna, and a communication bus to communicatively interconnect the visual indicator(s), the one audible indicator(s), the transceiver, the power source, the processor, the memory device(s), and the antenna of the remote unit.

Still another aspect of the invention is to provide a wireless alarm system including a master control unit, a slave unit(s), and a remote unit(s), wherein the master control unit assigns a predetermined wireless frequency to the master control unit, prevents the wireless alarm system to be turned off by anyone except an authorized user, and removes control from an authorized user of the master control unit.

Yet another aspect of the invention is to provide a wireless alarm system including a master control unit, a slave unit(s), and a remote unit(s), wherein the master control unit activates a visual indicator(s): if tampering occurs with the slave unit(s); if a slave unit(s) has been preset with a predetermined frequency of the master control unit, wireless communication between the master control unit and the slave unit(s) has been established, and any disruption of wireless communication occurs between the master control unit and the slave unit(s) occurs; if a door is opened in a cargo area of a vehicle wherein the master control unit resides; if a user forgets to turn off the wireless alarm system before unhooking and removing a trailer from a truck cab; or if separation between a cargo area of a vehicle and a cab of the vehicle, within which the master control unit resides, exceeds a predetermined distance threshold.

Still another aspect of the invention is to provide a wireless alarm system including a master control unit, a slave unit(s), and a remote unit(s), wherein the master control unit resets a visual indicator(s) of the master control unit upon depression of a reset button.

Yet another aspect of the invention is to provide a wireless alarm system including a master control unit, a slave unit(s), and a remote unit(s), wherein the master control unit activates an audible indicator(s): if tampering occurs with at least one of said at least one slave unit; if a slave unit(s) has been preset with a predetermined frequency of the master control unit, wireless communication between the master control unit and the slave unit(s) has been established, and any disruption of wireless communication occurs between the master control unit and the slave unit(s) occurs; if a door is opened in a cargo area of a vehicle wherein the master control unit resides; if a user forgets to turn off the wireless alarm system before unhooking and removing a trailer from a truck cab; or if separation between a cargo area of a vehicle and a cab of the vehicle, within which the master control unit resides, exceeds a predetermined distance threshold.

Still another aspect of the invention is to provide a wireless alarm system including a master control unit, a slave unit(s), and a remote unit(s), wherein the master control unit resets an audible indicator(s) of the master control unit upon depression of a reset button.

Yet another aspect of the invention is to provide a wireless alarm system including a master control unit, a slave unit(s), and a remote unit(s), wherein the master control unit initiates a reset function of the master control unit upon depression of a reset button.

Still another aspect of the invention is to provide a wireless alarm system including a master control unit, a slave unit(s), and a remote unit(s), wherein the master control unit bypasses an audible indicator(s) to allow door opening of a cargo area of a vehicle wherein the master control resides; and illuminates a visual indicator(s) to inform a user that the audible indicator(s) of the master control unit has been bypassed and requires resetting.

It is another aspect of the invention to provide a wireless alarm system including a master control unit, a slave unit(s), and a remote unit(s), wherein the wireless alarm system protects a cargo area of a truck and any containers therein, and wherein the slave unit includes a visual indicator(s), a lock, an input/output connector(s), a power source, a transceiver, a processor, a memory, an antenna, and a communication bus to communicatively interconnect the visual indicator(s), the lock, the input/output connector(s), the power source, the transceiver, the processor, the memory, and the antenna of the slave unit(s).

It is a further aspect of the invention to provide a wireless alarm system including a master control unit, a slave unit(s), and a remote unit(s), wherein the wireless alarm system protects a cargo area of a truck and any containers therein, and wherein the remote unit(s) includes a visual indicator(s), an audible indicator(s), a transceiver, a power source, a processor, a memory device(s), an antenna, and a communication bus to communicatively interconnect the visual indicator(s), the audible indicator(s), the transceiver, the power source, the processor, the memory device(s), and the antenna of the remote unit(s).

It is an aspect of the invention to provide improved elements and arrangements thereof in a wireless alarm system for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of a truck equipped with a wireless alarm system according to the present invention.

FIG. 2 is a front perspective view of a master control unit of a wireless alarm system according to the present invention.

FIG. 3 is a block diagram of a master control unit of a wireless alarm system according to the present invention.

FIG. 4 is a front perspective view of a slave unit of a wireless alarm system according to the present invention.

FIG. 5 is an exploded front perspective view of a slave unit of a wireless alarm system according to the present invention.

FIG. 6 is a front perspective view of a slave unit of a wireless alarm system according to the present invention in combination with a door switch.

FIG. 7 is a block diagram of a slave unit of a wireless alarm system according to the present invention.

FIG. 8 is a block diagram of a remote unit of a wireless alarm system according to the present invention.

Similar reference characters denote corresponding features consistently throughout the attached drawings.

### DETAILED DESCRIPTION OF THE PREFERRED EMBODIMENTS

The present invention is a wireless alarm system. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

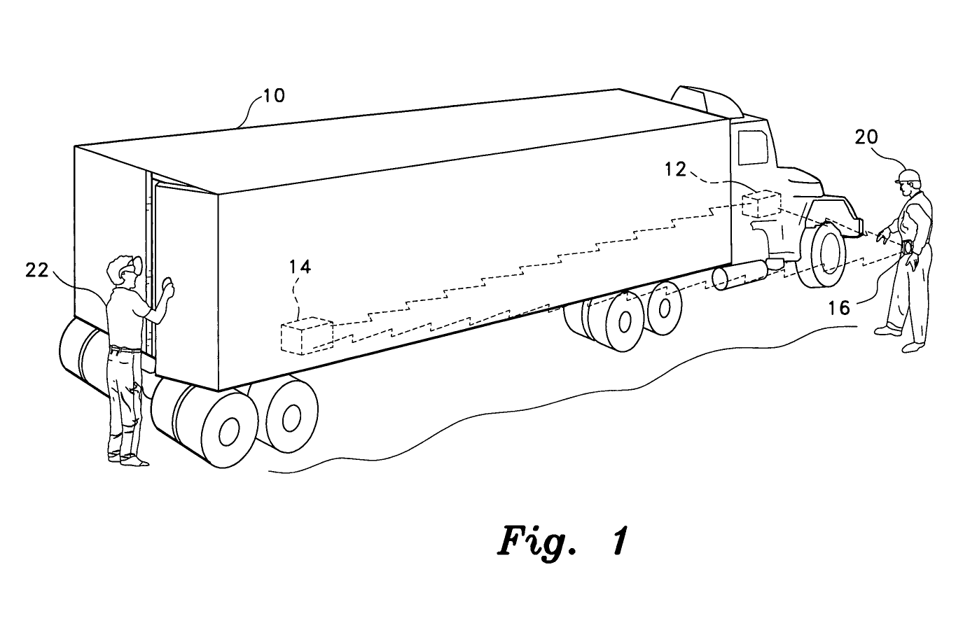

Referring to the drawings, FIG. 1 illustrates a truck 10 equipped with a wireless alarm system according to the invention for the protection of the cargo area of the truck 10 and containers therein. The wireless alarm system includes a master control unit 12, at least one slave unit 14, and at least one remote unit 16. A truck driver 20 carries a remote unit 16 so that the driver 20 may be alerted when the door of the cargo area of the truck 10 is opened by an unauthorized individual 22, or if separation between the cargo area of the truck 10 and the cab of the truck 10 exceeds a predetermined distance threshold.

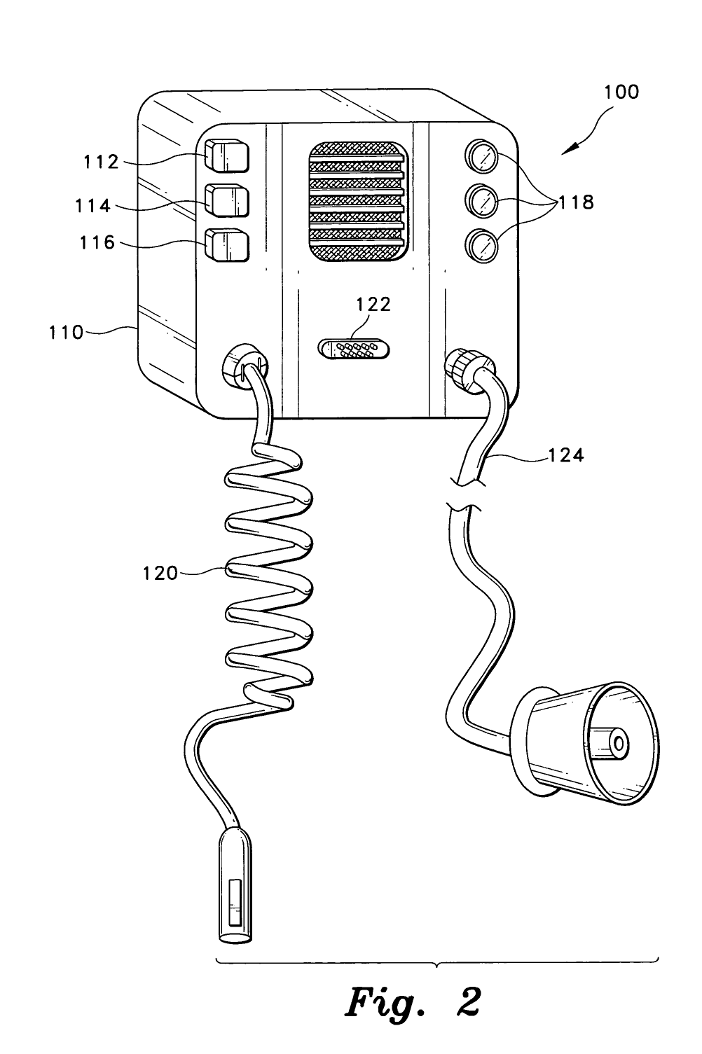

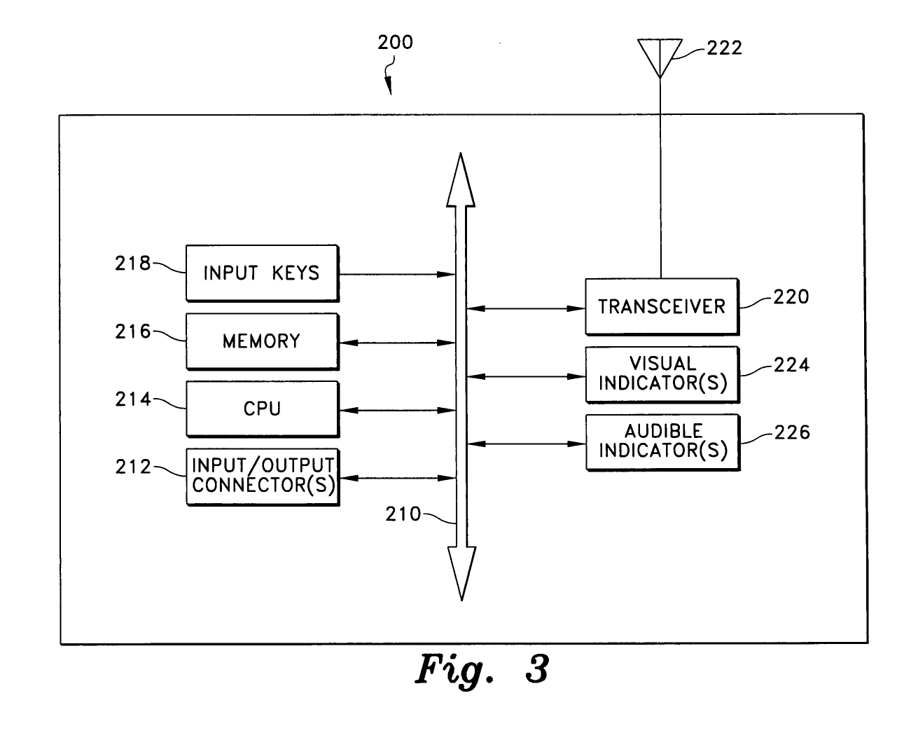

FIGS. 2 and 3 illustrate a master control unit of a wireless alarm system according to the invention. In FIG. 2, master control unit 100 includes a housing 110 that is configured to be located in the tractor or cab of a truck. Housing 110 may be made of any durable material, such as metal, plastic, or the like, and the particular size and/or dimensions of housing 110 may vary according to the desires of the user. Master control unit 100 may include at least one control button 112, 114, 116, at least one visual indicator 118, at least one audible indicator, at least one input/output connector (not shown), an external transceiver connector 122, and a transceiver (not shown). Alternatively, master control unit 100 may include a keypad (not shown) rather than the at least one control button 112, 114, 116 for easier control of functions.

For example, master control 100 is shown in FIG. 2 with a POWER ON/OFF button 112, an ALARM button 114, a SILENCE button 116, visual indicators 118, an input/output connector (not shown) for interconnecting housing 110 with power plug 120, an external transceiver connector 122 for interconnecting housing 110 with a transceiver (not shown) from a slave unit 14, and an input/output connector (not shown) for interconnecting housing 110 with an external speaker 124. POWER ON/OFF button 112 may indicate, via a color, such as green or the like, whether master control unit 100 is powered.

ALARM button 114 may illuminate with the appearance of a color, such as red or the like, whether the wireless alarm system is set, and may flash and/or illuminate to indicate an ‘alarm on’ condition, an ‘alarm fault’ condition, or the like. For example, ALARM button 114 may illuminate if tampering occurs with a slave unit 14, may illuminate if a slave unit 14 has been preset with a predetermined frequency of master control unit 100, wireless communication between master control unit 100 and the slave unit 14 has been established, and any disruption of wireless communication occurs between master control unit 100 and the slave unit 14 occurs, may illuminate if a door is opened in the cargo area of a vehicle wherein master control unit 100 resides, may illuminate if a user forgets to turn off an active wireless alarm system before unhooking and removing a trailer from a truck cab, may illuminate if separation between the cargo area of a vehicle and the cab of the vehicle exceeds a predetermined distance threshold, may illuminate if any undefined condition occurs within master control unit 100, any associated slave units 14, and/or any associated remote units 16, or the like.

SILENCE button 116 may enable a user to silence master control unit 100 if the wireless alarm system inadvertently activates and/or to enable a user to deactivate wireless alarm system audible indicator(s) to allow a user to open truck doors for loading and/or unloading. SILENCE button 116 may also enable a user to bypass wireless alarm audible indicator(s) while maintaining supervision of a sensor and/or switch connected with an associated slave unit. Master control unit 100 also includes any well known transceiver (not shown) configured to enable master control unit to wirelessly communicate with slave unit(s) 14 and/or remote unit(s) 16. Master control unit 100 may also be configured with a keypad to enable a user to easily program and/or reprogram functions of master control unit 100.

As shown in FIG. 3, transceiver 220 of master control unit 200 may be any known transceiver or transmitter/receiving device that enables wireless intercommunication between a master control unit 12, associated slave units 14, and/or associated remote units 16. Transceiver 220 may be configured to communicate via any known radio frequency according to the desires of the user. Visual indicator(s) 224 are configured to provide visual indication to a user, and audible indicator(s) 226 are configured to provide audible indication to a user. Visual indicator(s) 224 may be any known type of visual indicator, such as light emitting diodes or the like, and audible indicator(s) 226 may be any known type of audible indicator configured to emit any type of sound, such as a horn, siren, alarm, or the like.

The input/output connectors and the external transceiver connector 122 of master control unit 100 (see FIG. 2) may be any type of connector known in the art, such as PCI connectors, ISA connectors, FC-AL connectors, IDE connectors, SCSI connectors, USB connectors, or the like. An input/output connector configured for interconnecting the master control unit 100 to an external power source, such as the vehicle battery or the like, facilitates easy removal and/or relocation to another vehicle.

Master control unit 200 includes a communication bus 210 to communicatively interconnect input keys 218, visual indicator(s) 224, audible indicator(s) 226, input/output connector(s) 212, transceiver 220, CPU 214, memory. 216, and antenna 222. These elements are all well known in the art and may be configured according to the desires of the user. Master control unit 200 may also be configured for effectively interacting with any known satellite tracking system, such as GPS or GLONASS, to enable the wireless alarm system to send a signal, upon detachment of a trailer from a truck cab or the like, to individuals at a remote security location who could locate where separation of the trailer and truck cab occurred, and/or alert a trucking firm and/or authorities.

CPU 214 of master control unit 200 includes an arithmetic/logic unit that is interconnected with memory 216 via communication bus 210. Memory 216 includes ROM(s) and RAM(s). The ROM(s) store computer useable program code that is read and processed by CPU 214, and that causes CPU 214 to perform programmed functions. The ROM(s) may be electronically alterable (e.g., EPROM, EEPROM, or the like) so that the processing circuitry can be readily adapted to a particular vehicle configuration. Movement and process of instructions as well as data is controlled and accomplished by CPU 214. The RAM(s) and the ROM(s) may be connected to the CPU 214 through several signal paths.

CPU 214 of master control unit 200 may execute various programs under the control of the operating system of master control unit 200. For example, computer instructions configured using any computer useable software code stored in the ROM(s) of master control unit 200 may include first instruction means for assigning a predetermined wireless frequency to master control unit 200, second instruction means for activating visual and/or audible indicator(s) 224 and 226 on master control unit 200 if tampering occurs with a slave unit, third instruction means for not allowing the wireless alarm system to be turned off by anyone except the user, fourth instruction means for removing control from a user of master control unit 200.

Any computer useable software code stored in the ROM of master control unit 200 may also include fifth instruction means for activating visual and/or audible indicator(s) 224, 226 of master control unit 200 if a slave unit has been preset with a predetermined frequency of master control unit 200, wireless communication between master control unit 200 and the slave unit has been established, and any disruption of wireless communication occurs between master control unit 200 and the slave unit occurs, sixth instruction means for activating visual and/or audible indicator(s) 224, 226 of master control unit 200 if a door is opened in the cargo area of a vehicle wherein master control unit 200 resides, seventh instruction means for activating visual and/or audible indicator(s) 224 and 226 on master control unit 200 if a user forgets to turn off the wireless alarm system before unhooking and removing a trailer from a truck cab, eighth instruction means for activating visual and/or audible indicator(s) 224, 226 if separation between the cargo area of a vehicle and the cab of the vehicle, within which the master control unit resides, exceeds a predetermined distance threshold.

The wireless alarm system may also include a reset button interconnected with master control unit 200, and any computer useable software code stored in the ROM of master control unit 200 may also include ninth instruction means for resetting visual and/or audible indicator(s) of master control unit 200 upon depression of the reset button and/or initiation of a reset function within master control unit 200, tenth instruction means for activating a visual and/or audible indicator(s) 224, 226 of master control unit 200 if any undefined condition occurs within master control unit 200, any associated slave units, and/or any associated remote units, eleventh means for bypassing audible indicator(s) to allow door opening of the cargo area of a vehicle wherein master control resides, twelfth instruction means for illuminating a visual indicator 218 to inform a user that audible indicator(s) 224, 226 of master control unit 200 have been bypassed and require resetting, or the like.

The RAM of master control unit 200 may be a writable memory used as an area for reading programs executed in CPU 214 or a work area for writing data to be processed by execution programs. The RAM may include volatile and/or non-volatile RAM. Volatile RAM may include any known volatile RAM configuration, static RAM, DRAM, synchronous DRAM, or the like. Non-volatile RAM may include EEPROM, PRAM, Flash memory, or the like.

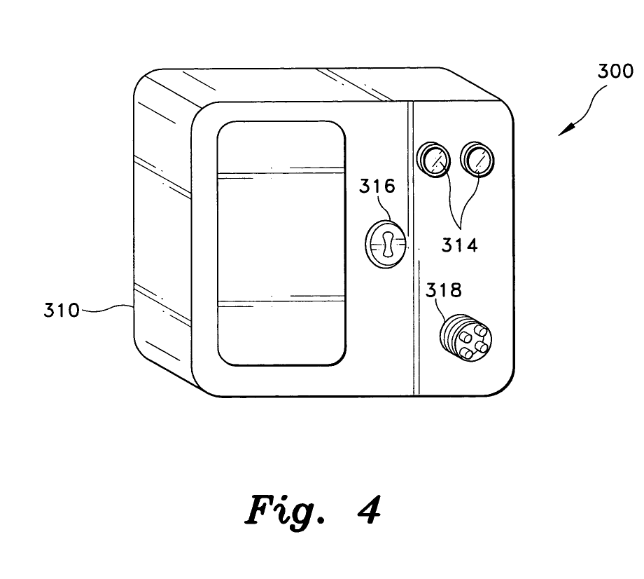

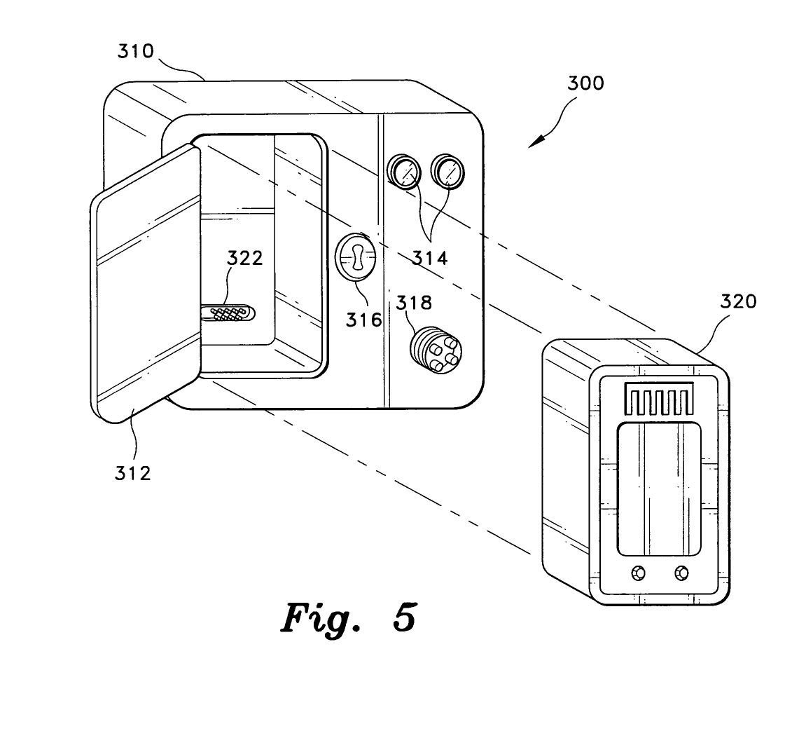

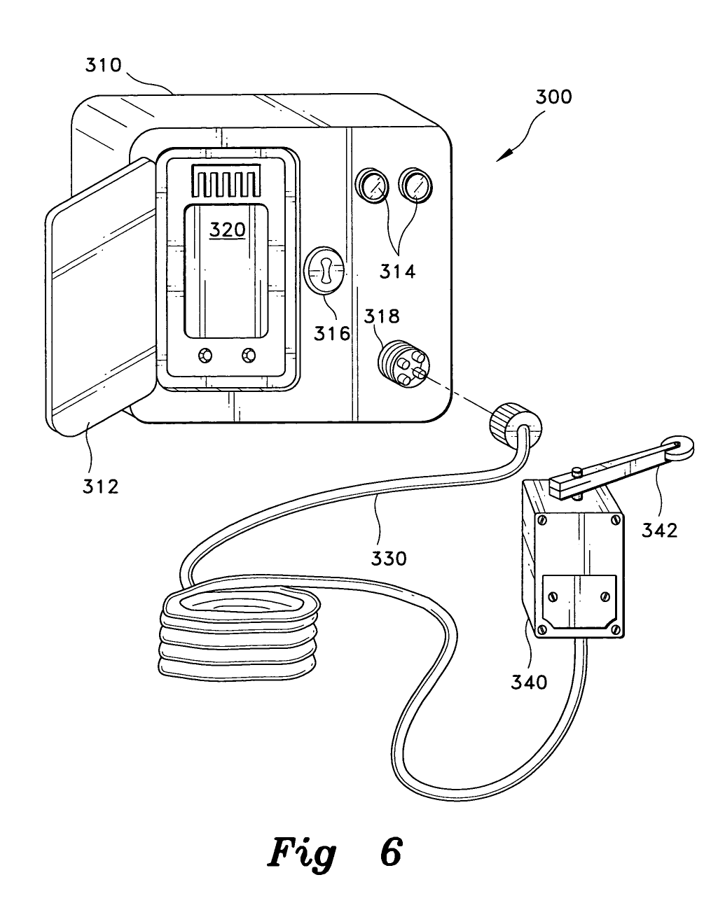

As shown in FIGS. 4-6, a slave unit 300 of a wireless alarm system according to the invention includes a housing 310 that is configured to be located in the cargo area of a truck. Housing 310 may be made of any durable material, such as metal, plastic, or the like, and the particular size and/or dimensions of the housing may vary according to the desires of the user. Slave unit 300 may include at least one visual indicator 314, a lock 316, at least one input/output connector 318, a transceiver 320, and a power source (not shown). Slave unit 300 also includes a door 312 that opens and secures, via lock 316, an interior compartment for removably holding transceiver 320. The interior compartment of slave unit 300 includes a transceiver connector 322 to interconnect the interior compartment with transceiver 320.

Slave unit 300 is configured and arranged to operationally monitor whether a door of the vehicle in which it is stored is open or closed, and whether lock 316 of door 312 of the interior compartment has been damaged and/or is not secure. The at least one visual indicator 314 of slave unit 300 is configured to provide visual indication to a user. The at least one visual indicator 314 of slave unit 300 may be any known type of visual indicator, such as light emitting diodes or the like. Lock 316 of slave unit 300 may be any known type of lock. The at least one input/output connector 318 of slave unit 300 may be configured to enable interconnection of an external sensor or switch 340, 342 via a cable 330. Such a sensor or switch 340, 342 may be any known sensor or switch, such as a limit switch, a plunger switch, a proximity switch, or the like.

Transceiver 320 of slave unit 300 may be any known transceiver and may be configured to communicate via any known radio frequency according to the desires of the user. Transceiver 320 of slave unit 300 includes a transceiver connector (not shown) for removably interconnecting transceiver 320 with transceiver connector 322 in the interior compartment of slave unit 300, and with external transceiver connector 122 on master control unit 100 (see FIG. 2). External transceiver connector 122 of master control unit 100 and the transceiver connector of transceiver 320 of slave unit 300 are preferably the same type of transceiver connector to enable simple and easy interconnection of the transceiver connector of a transceiver of any slave unit with the external transceiver connector of any master control unit. The power source of slave unit 300 may be any known power source, such as a conventional battery, a rechargeable battery, or the like.

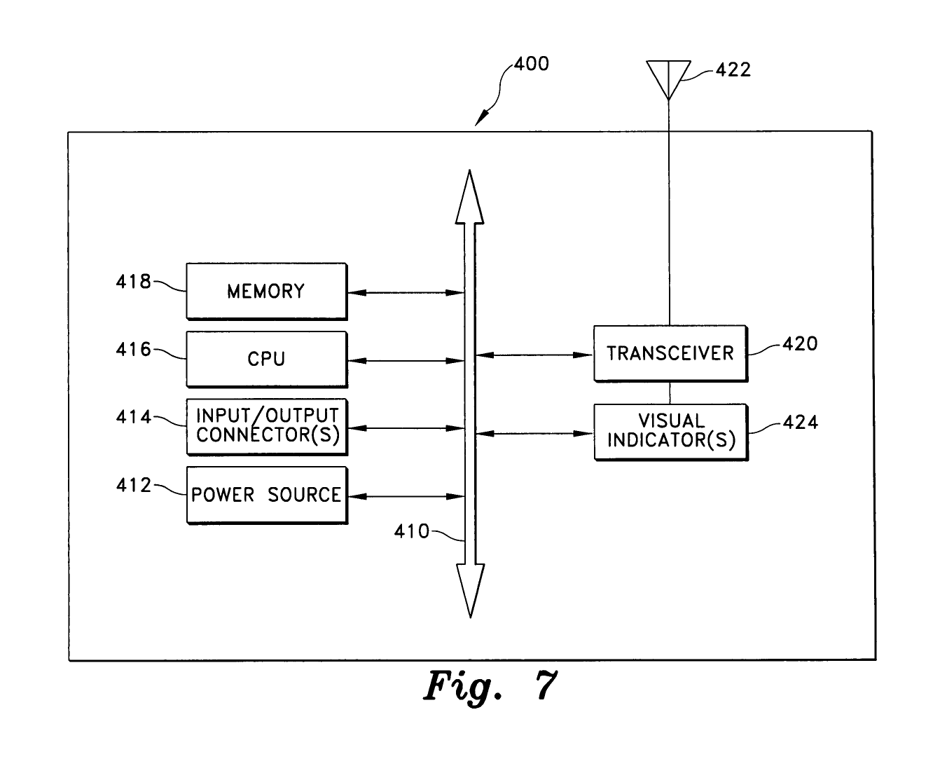

As shown in FIG. 7, major known electrical components are mounted within the housing of slave unit 400. Such components may include a printed circuit board mounted in firm support within the slave housing. The circuit board carries certain coupling and driver electronics with CPU 416 and memory 418, such as a ROM and/or a RAM. In general, ROM is used to contain instructions and programs while RAM is employed for operating and working data.

CPU 416 of slave unit 400 may execute various programs under the control of the operating system of the slave unit. For example, any computer useable software code stored in the ROM of slave unit 400 may include first instruction means for automatically setting the wireless frequency of the slave unit to a predetermined wireless frequency of a designated master control unit upon interconnection of the slave unit with the designated master control unit, second instruction means for transmitting a signal to an associated master control unit if the voltage of the power source of the slave unit decreases beneath a predetermined voltage threshold for a predetermined time period, or the like.

Slave unit 400 includes communication bus 410 to communicatively interconnect visual indicator(s) 424, the lock (not shown), input/output connector(s) 414, power source 412, transceiver 420, CPU 416, memory 418, and antenna 422. These elements are all well known in the art, as described above, and may be configured according to the desires of the user.

Transceiver 420 of slave unit 400 is configured to automatically set itself to the predetermined frequency of a designated master control unit upon interconnection with the designated master control unit. This enables any slave unit which has been previously used with one master control unit to be readily configured for use with another master control unit. This also enables a plurality of slave units to be readily configured for use with one particular master control unit. Once a slave unit has been preset with a predetermined frequency of a designated master control unit, and has been subsequently interconnected with the input/output connector of the slave unit, the slave unit may then establish wireless communication with the master control unit at the predetermined frequency of the master control unit. Once wireless communication between the slave unit and a particular master control unit has been established, any disruption of wireless communication between the slave unit and the particular master control unit may result in activation by the particular master control unit of an audible and/or visual indication to alert a user of the particular master control unit.

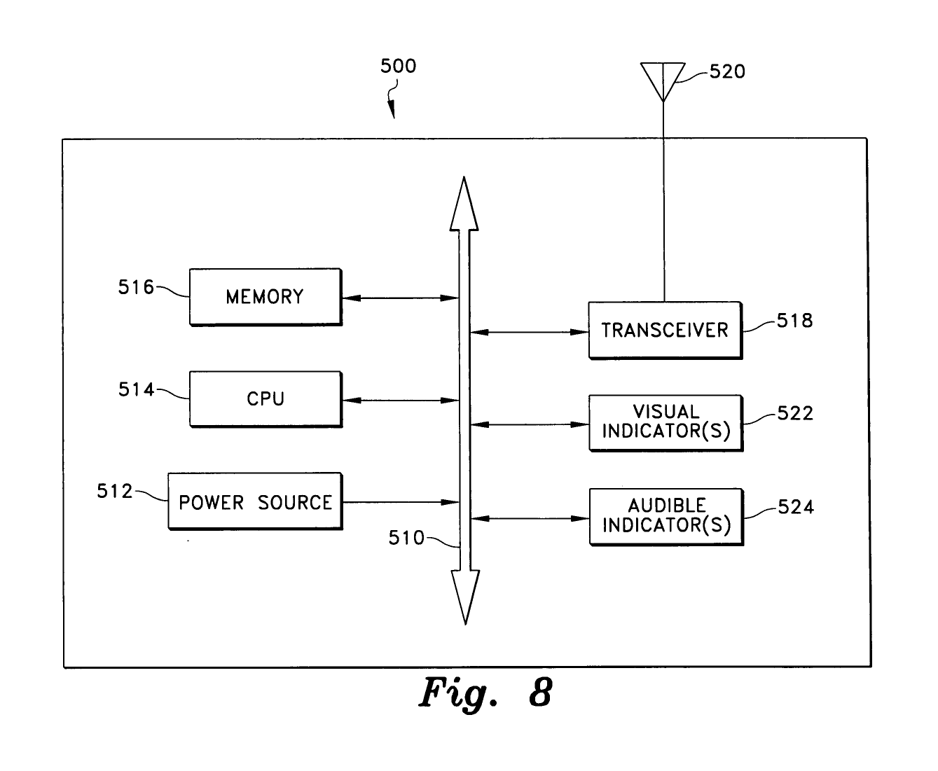

As shown in FIG. 8, a remote unit 500 of a wireless alarm system according to the invention may be configured in the form of a small communication device, such as a pager or the like, to enable a truck driver or passenger to easily carry a remote unit. Remote unit 500 includes a housing that may be made of any durable material, such as metal, plastic, or the like, and the particular size and/or dimensions the housing may vary according to the desires of the user. Remote unit 500 includes visual indicator(s) 522, audible indicator(s) 524, transceiver 518, and power source 512.

Visual indicator(s) 522 of remote unit 500 is configured to provide visual indication to a user, and audible indicator(s) 524 of remote unit 500 is configured to provide audible indication to a user. Visual indicator(s) 522 of remote unit 500 may be any known type of visual indicator, such as light emitting diodes or the like, and audible indicator(s) 524 may be any known type of audible indicator configured to emit any type of sound, such as a horn, siren, alarm, or the like. Transceiver 518 of remote unit 500 may be any known transceiver and may be configured to any well known transceiver configured to enable remote unit 500 to wirelessly communicate with a master control unit and/or slave units via any known radio frequency according to the desires of the user. Power source 512 of remote unit 500 may be any known power source, such as a conventional battery, a rechargeable battery, or the like.

Major known electrical components are mounted within the housing of remote unit 500. Such components may include a printed circuit board mounted in firm support within the remote unit housing. The circuit board carries certain coupling and driver electronics with CPU 514 and memory 516, such as a ROM and/or a RAM. In general, ROM is used to contain instructions and programs while RAM is employed for operating and working data.

Remote unit 500 includes a communication bus 510 to communicatively interconnect the visual indicator(s) 522, the audible indicator(s) 524, transceiver 518, power source 512, CPU 514, memory 516, and antenna 520 of remote unit 500. These elements are all well known in the art, as described above, and may be configured according to the desires of the user.

Referring to FIG. 1, master control unit 12 maintains radio contact with slave unit 14 located inside the cargo area of the vehicle 10. Master control unit controls communication signals between slave unit 14 and/or remote unit 16. Slave unit 14 monitors the trailer door via any known proximity sensor, such as a door switch or the like, and will signal master control unit 12 when the door is opened.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A wireless alarm system comprising:
a master control unit;
at least one slave unit; and
at least one remote unit,
wherein the wireless alarm system protects a cargo area of a truck and any containers therein.

2. The wireless alarm system according to claim 1, wherein said master control unit comprises:
at least one control button;
at least one visual indicator;
at least one audible indicator;
at least one input/output connector;
a transceiver;
a processor;
a memory;
an antenna; and
a communication bus to communicatively interconnect the at least one control button, the at least one visual indicator, the at least one audible indicator, the at least one input/output connector, the transceiver, the processing unit, the memory, and the antenna of said master control unit.

3. The wireless alarm system according to claim 2, wherein the memory carries therein computer useable software code which, when executed by the processor of the master control unit, causes the processor to carry out steps comprising:
assigning a predetermined wireless frequency to said master control unit;
preventing said wireless alarm system to be turned off by anyone except an authorized user; and
removing control from an authorized user of said master control unit.

4. The wireless alarm system according to claim 3, wherein the memory carries therein computer useable software code which, when executed by the processor of the master control unit, further causes the processor to carry out steps comprising:
activating at least one of said at least one visual indicator if tampering occurs with said at least one of said at least one slave unit.

5. The wireless alarm system according to claim 3, wherein the memory carries therein computer useable software code which, when executed by the processor of the master control unit, further causes the processor to carry out steps comprising:
activating at least one of said at least one audible indicator if tampering occurs with at least one of said at least one slave unit.

6. The wireless alarm system according to claim 3, wherein the memory carries therein computer useable software code which, when executed by the processor of the master control unit, further causes the processor to carry out steps comprising:
activating at least one of said at least one visual indicator if at least one of said at least one slave unit has been preset with a predetermined frequency of said master control unit wireless, communication between said master control unit and said at least one of said at least one slave unit has been established, and any disruption of wireless communication occurs between said master control unit and said at least one of said at least one slave unit occurs.

7. The wireless alarm system according to claim 3, wherein the memory carries therein computer useable software code which, when executed by the processor of the master control unit, further causes the processor to carry out steps comprising:
activating at least one of said at least one audible indicator if at least one of said at least one slave unit has been preset with a predetermined frequency of said master control unit wireless, communication between said master control unit and said at least one of said at least one slave unit has been established, and any disruption of wireless communication occurs between said master control unit and said at least one of said at least one slave unit occurs.

8. The wireless alarm system according to claim 3, wherein the memory carries therein computer useable software code which, when executed by the processor of the master control unit, further causes the processor to carry out steps comprising:
activating at least one of said at least one visual indicator if a door is opened in a cargo area of a vehicle wherein said master control unit resides.

9. The wireless alarm system according to claim 3, wherein the memory carries therein computer useable software code which, when executed by the processor of the master control unit, further causes the processor to carry out steps comprising:
activating at least one of said at least one audible indicator if a door is opened in a cargo area of a vehicle wherein said master control unit resides.

10. The wireless alarm system according to claim 3, wherein the memory carries therein computer useable software code which, when executed by the processor of the master control unit, further causes the processor to carry out steps comprising:
activating at least one of said at least one visual indicator on said master control unit if a user forgets to turn off the wireless alarm system before unhooking and removing a trailer from a truck cab.

11. The wireless alarm system according to claim 3, wherein the memory carries therein computer useable software code which, when executed by the processor of the master control unit, further causes the processor to carry out steps comprising:
activating at least one of said at least one audible indicator on said master control unit if a user forgets to turn off the wireless alarm system before unhooking and removing a trailer from a truck cab.

12. The wireless alarm system according to claim 3, wherein the memory carries therein computer useable software code which, when executed by the processor of the master control unit, causes the processor to carry out steps comprising:
activating at least one of said at least one visual indicator if separation between a cargo area of a vehicle and a cab of the vehicle, within which said master control unit resides, exceeds a predetermined distance threshold.

13. The wireless alarm system according to claim 3, wherein the memory carries therein computer useable software code which, when executed by the processor of the master control unit, causes the processor to carry out steps comprising:
activating at least one of said at least one audible indicator if separation between a cargo area of a vehicle and a cab of the vehicle, within which said master control unit resides, exceeds a predetermined distance threshold.

14. The wireless alarm system according to claim 3, wherein the wireless alarm system further comprises a reset button interconnected with said master control unit, and the memory carries therein computer useable software code which, when executed by the processor of the master control unit, further causes the processor to carry out steps comprising:
resetting at least one of said at least one visual indicator of said master control unit upon depression of the reset button.

15. The wireless alarm system according to claim 3, wherein the wireless alarm system further comprises a reset button interconnected with said master control unit, and the memory carries therein computer useable software code which, when executed by the processor of the master control unit, further causes the processor to carry out steps comprising:
resetting at least one of said at least one audible indicator of said master control unit upon depression of the reset button.

16. The wireless alarm system according to claim 3, wherein the wireless alarm system further comprises a reset button interconnected with said master control unit, and the memory carries therein computer useable software code which, when executed by the processor of the master control unit, further causes the processor to carry out steps comprising:
initiating a reset function of said master control unit upon depression of the reset button.

17. The wireless alarm system according to claim 3, wherein the memory carries therein computer useable software code which, when executed by the processor of the master control unit, further causes the processor to carry out steps comprising:
bypassing at least one of said at least one audible indicator to allow door opening of a cargo area of a vehicle wherein said master control resides; and
illuminating at least one visual indicator to inform a user that said at least one audible indicator of said master control unit has been bypassed and requires resetting.

18. The wireless alarm system according to claim 1, wherein said at least one slave unit comprises:
at least one visual indicator;
a lock;
at least one input/output connector;
a power source;
a transceiver;
a processor;
a memory;
an antenna; and
a communication bus to communicatively interconnect the at least one visual indicator, the lock, the at least one input/output connector, the power source, the transceiver, the processor, the memory, and the antenna of the slave unit.

19. The wireless alarm system according to claim 1, wherein said at least one remote unit comprises:
at least one visual indicator;
at least one audible indicator;
a transceiver;
a power source;
a processor;
at least one memory device;
an antenna; and
a communication bus to communicatively interconnect the at least one visual indicator, the at least one audible indicator, the transceiver, the power source, the processor, the at least one memory device, and the antenna of the remote unit.
